(19) United States
(12) Patent Application Publication
(10) Pub. No.: US 2007/0292641 A1
(43) Pub. Date: Dec. 20, 2007

(54) Non-round plastic pressurized dispenser

(76) Inventors: Gene Michael Altonen, West Chester, OH (US); Michael Thomas Dodd, Florence, KY (US); Ayub Ibrahim Khan, Cincinnati, OH (US); William Dale Murdock, Cheviot, OH (US); Daniel Jonathan Quiram, Midlothian, VA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/454,806

(22) Filed: Jun. 16, 2006

(51) Int. Cl. B32B 27/32

(52) U.S. Cl. 428/35.2

(57) ABSTRACT

A plastic pressurized package comprising a hollow, plastic, substantially non-round cross-section body, comprising a polymer selected from the group consisting of polyamides, polyesters, polyester copolymers, polycarbonates, polyacrylates, polycarbonate copolymers, and mixtures thereof wherein said plastic pressurized package is able to contain and dispense a pressurized fluid of at least about 15 psi greater than atmospheric pressure at 25° C.

### FIELD OF THE INVENTION

The present invention relates to a plastic pressurized package that is substantially non-round in cross-section and capable of being exposed to and containing a variety of personal care products, has high impact resistance, chemical resistance and thermal stability.

### BACKGROUND OF THE INVENTION

Pressurized or aerosol antiperspirant products have been marketed for many years. These products are typically packaged in metal cans or glass containers. For many products, it is advantageous for the package to be clear to permit the contents to be viewed by a user. While glass provides this option, it is typically expensive and can be very fragile when dropped. A much less common material used to form a pressurized package is plastic. Plastics, such as grades of amorphous polyamide and polyester, provide a clear container for viewing purposes and have the added advantages of being less fragile and more economical to produce versus glass. Also, unlike metal aerosol containers, plastic aerosols can be formed into a variety of shapes and cross-sections. Most existing plastic aerosol packages, however, are limited to round cross-sections in order to ensure that certain performance and safety requirements are met as required prior to distribution and use. Because plastic pressurized containers are also known to have several disadvantages, standard test procedures, such as British Standard 5597:1991, provides a means for ensuring the package is safe under normal usage conditions.

A common disadvantage to a pressurized plastic container includes the fact that existing plastic pressurized containers are typically comprised of polyester terephthalate (PET) which has a thermal softening point of about 60-66° C. This is undesirable since it is possible, in fact likely, that a plastic container will be exposed to temperatures above 60° C., or even higher than about 70° C., particularly inside an automobile on a hot summer day. While certain plastic materials, such as polyester naphthalate (PEN), polyarylate (PAR), and blends of polyesters have been used by some manufacturers to increase the thermal softening point to above 90° C., these materials are very expensive relative to PET. Also, PEN and PAR have a yellow hue and thus, are not well suited for certain applications since they have relatively poor optical clarity. Thus, there is a need for an affordable material option that provides plastic pressurized containers with structural integrity at temperatures above 60° C. or even above 70° C. while providing good optical clarity.

Another disadvantage is that existing plastic pressurized containers generally cannot survive drop impacts of greater than about 6 feet. While this is generally considered an acceptable level of impact resistance by those skilled in the art, it is the intent of the present invention to provide a container with even greater resistance to impact, since in certain circumstances it is possible that the container could be exposed to impact stresses exceeding a 6 foot drop impact, such as when dropped from the top shelf in a retail store.

Further, many existing plastic pressurized containers are susceptible to degradation by many solvents commonly used in consumer products. When the plastic material used to form a plastic pressurized container is degraded by a solvent, the ability of the container to contain pressure, resist impact, and to provide good optical clarity can be diminished. Providing a plastic material that resists degradation caused by common solvents results in a plastic pressurized container that is better suited to contain a large range of consumer products and thus, has greater commercial value. The present invention, therefore, provides the advantage of making a more economical, structurally sound and aesthetically-pleasing package that is capable of containing a wide range of consumer products.

### SUMMARY OF THE INVENTION

The present invention relates to a plastic pressurized package comprising a hollow, plastic, substantially non-round cross-section body, comprising a polymer selected from the group consisting of polyamides, polyesters, polyester copolymers, polycarbonates, polyacrylates, polycarbonate copolymers, and mixtures thereof wherein said plastic pressurized package is able to contain and dispense a pressurized fluid of at least about 15 psi greater than atmospheric pressure at 25° C.

The present invention also relates to a plastic pressurized package comprising a hollow, plastic, substantially non-round cross-section body, comprising a blend of a first and second material, said first material comprising a polymer selected from the group consisting of polyesters, polyester copolymers and mixtures thereof and said second material comprising a polymer selected from the group consisting of polyamides, polycarbonates, polyacrylates, polycarbonate copolymers, polyesters, polyester copolymers and mixtures thereof wherein said first material and said second material are different and wherein said plastic pressurized package is able to contain and dispense a pressurized fluid of at least about 15 psi greater than atmospheric pressure at 25° C.

Finally, the present invention also relates to a plastic pressurized package comprising a hollow, plastic, substantially non-round cross-section body, comprising a polymer selected from the group consisting of polyamides, polyesters, polyester copolymers, polycarbonates, polyacrylates, polycarbonate copolymers, polypropylene, cyclic polyolefin copolymer, polystyrene, Barex, styrene acrylonitrile copolymer and mixtures thereof wherein said plastic pressurized package is able to contain and dispense a pressurized fluid of at least about 15 psi greater than atmospheric pressure at 25° C.

### DETAILED DESCRIPTION OF THE INVENTION

The present invention relates to a plastic pressurized package capable of being exposed to and containing a variety of personal care products, has high impact resistance, chemical resistance and thermal stability. By combining two or more materials that form the walls of the package, the present invention provides substantial advantages in achieving an ideal combination of physical and chemical properties that are not typical in a glass and metal aerosol packages.

While the specification concludes with the claims particularly pointing and distinctly claiming the invention, it is believed that the present invention will be better understood from the following description.

Except where specific examples of actual measured values are presented, numerical values referred to herein should be considered to be qualified by the word “about”.

As used herein, “comprising” means that other steps which do not affect the end result can be added. This term encompasses the terms “consisting of” and “consisting essentially of”. The methods/processes of the present invention can comprise, consist of, and consist essentially of the essential elements and limitations of the invention described herein, as well as any of the additional or optional components, steps, or limitations described herein.

All percentages, parts and ratios are based upon the total weight of the compositions of the present invention, unless otherwise specified. All such weights as they pertain to listed ingredients are based on the active level and, therefore, do not include solvents or by-products that may be included in commercially available materials, unless otherwise specified. The term “weight percent” may be denoted as “wt. %” herein.

It is also herein contemplated that the present invention may be practiced with many consumer products including, but not limited to, antiperspirants, deodorants, hair products, household products, cooking sprays, beverages, perfumes, shaving creams/gels, or drug products.

The term “non-round” is defined herein as the shape of the pressurized plastic dispenser of the present invention wherein the shape, when viewed in any cross-section, is substantially not geometrically round and is capable of substantially maintaining said shape when subjected to the pressure exerted by the contents within the plastic package of the present invention. For example, shapes of the present invention, when viewed in cross-section, may include, but are not limited to, square, rectangle, oval, star, heart, diamond, polygons, trapezoid, rhombus, triangle, and the like.

The term “plastic” is defined herein as any polymeric material that is capable of being shaped or molded, with or without the application of heat. Usually plastics are a homo-polymer or co-polymer of high molecular weight. Plastics fitting this definition include, but are not limited to, polyolefins, polyesters, nylon, vinyl, acrylic, polycarbonates, polystyrene, and polyurethane.

The term “clear” is defined herein as having the property of transmitting light without appreciable scattering so that bodies lying behind are perceivable. One acceptable test method for determining whether a product is clear is to attempt to read a series of words placed immediately behind the package. The words being printed in black color, 14 point Times New Roman font, printed on a white sheet of paper with the printed side of the paper attached to the back of the package. The word and/or letters must be visible and/or readable from the front of the package by an individual of reasonable eyesight and positioned directly in front of the package

The term “optical clarity” is defined herein as the ability of a material to transmit light through the material. Optical clarity is characterized by both the luminous transmittance of light through a material and also by its haze value (as defined in ASTM method D1003). The approximate haze level of a container can be determined by comparing the container to flat test samples having known haze values. The haze level of the container can be approximated by finding a test sample with a slightly lower haze value, and a sample having a slightly higher haze value. The approximate haze value of the container is based on the value found between the value of the two test samples. Haze values may be determined as described herein.

The term “tinted” is defined herein as the practice of adding a low level of pigment or dye into a material for the purpose of imparting a level of opacity, color, or opacity and color into the material.

The term “plastic package” refers to the container vessel of the pressurized package being made substantially of plastic. The sealing valve and actuator of the package may or may not necessarily be made substantially of plastic.

The term “pressurized plastic dispenser” or “pressurized plastic package” is defined herein as a container with fluid contents, such as propellants, wherein the fluid contents have a pressure of at least about 15 psi, at least about 30 psi, at least about 45 psi or at least about 60 psi greater than atmospheric pressure at 25° C. but no more than about 140 psi, no more than about 130 psi, no more than about 110 psi or no more than about 90 psi greater than atmospheric pressure at 25° C. The pressurized plastic package of the present invention is able to contain and dispense fluids with the above-mentioned pressure limitations while substantially maintaining a non-round cross-section shape.

The term “deform” or “deformation” describes the change in shape or form in a material caused by any type of stress, force or degradation. If a material exhibits excessive deformation, the material may exhibit a mode of failure such that the material breaks, expands or ruptures due to its inability to resist high temperatures, impact stresses, and contents of certain fluids or gases, particularly pressurized fluids.

The term “resistant to chemicals” or “chemical resistance” describes an opposition to certain chemicals that would normally degrade and/or crack the plastic material. These “certain chemicals” may be those commonly known as household solvents or solvents commonly used in consumer products. Such chemicals include, but are not limited to, ethanol, acetone, glycol, waxes, oils, hydrocarbon-based silicones, and the like. Resistance to common household solvents ensures that the container does not leak or rupture when exposed to certain liquids. Chemical resistance may be determined and measured as described herein.

The term “thermal resistance” refers herein to a pressurized container that shows no visible sign of deformation after exposure to high temperatures such as 58° C. for about 2 minutes, 60° C. for about 2 minutes, 65° C. for about 2 minutes or 70° C. for about 2 minutes.

The terms “crystalline” or “crystallizable” polyethylene terephthalate (PET), refers herein to PET homopolymers or copolymers that are capable of forming crystalline structures on cooling from the melt, or resulting from exposure to heat (thermal induced crystalinity) or immersion in a suitable solvent (solvent induced crystalinity).

The term “non-crystallizing” or “non-crystallizable” polyethylene terephthalate (PET), refers herein to PET copolymers (also called PET co-polyesters) that are substantially incapable of forming crystalline structures during cooling from the melt state or during exposure to heat (thermal induced crystalinity), or when exposed to solvents and vapors (solvent induced crystalinity).

The term “amorphous” PET, as used herein, refers to “non-crystallizing” or “non-crystallizable” polyethylene terephthalate (PET) that substantially resist the formation of crystalline structures resulting from exposure to heat (thermal induced crystalinity) or immersion in suitable solvents and vapors (solvent induced crystalinity).

As used herein, “polycarbonate (PC)” refers to polycarbonate of the types synthesized from Bisphenol A, those synthesized from alternative monomers, random copolymers, block copolymers, and blends thereof.

As used herein, “filler” includes materials included to reduce the total amount of polymer in a given space.

“Additives” refers to materials, known in the art to impart a desired property, including, but not limited to anti-stat, anti-scuff, optical brightness and the like.

### Plastic Pressurized Package

The plastic pressurized package of the present invention exhibits particular enhanced characteristics such that it is capable of containing and being exposed to a variety of personal care products, has high impact resistance, chemical resistance and thermal stability. The plastic pressurized package can be formed from a single material or from the combination of at least one first and second polymer material. Combining at least a first and second material to form the parts of the package provides substantial advantages in achieving an ideal combination of physical, chemical and aesthetic characteristics that are not typical in glass and/or metal aerosol packages. Colorants, fillers and additives can be incorporated into the polymer mixture to impart desirable aesthetics, mechanical, or functional properties.

Materials

Single Materials

If only a single material is used in the present invention, the materials may include, but are not limited to, polyamides, polyesters, polyester copolymers, polycarbonates (PC), polyacrylates, polycarbonate copolymers, and mixtures thereof. Polyesters may be selected from the group consisting of polyethylene terephthalate (PET), polyethylene naphthalate (PEN), polyarylate (PAR), and mixtures thereof. Polyester copolymers are preferably selected from the group consisting of polyethylene terephthalate glycol-modified (PETG), polycyclohexanedimethanol terephthalate (PCT), polycyclohexanedimethanol terephthalate isophthalate (PCTA), polycyclohexanedimethanol terephthalate glycol (PCTG), and mixtures thereof. The polyester copolymers preferably comprise monomers selected from the group consisting of isophthalic acid (IPA), terephthalic acid (TPA), butane diol (BD), cyclohexanedimethanol (CHDM), ethylene glycol (EG), diethylene glycol (DEG) and mixtures thereof. Additional materials useful for the present invention include, but are not limited to, polypropylene (PP), cyclic polyolefin copolymer (COC), polystyrene (PS), Barex (Impact modified acrylonitrile-methyl acrylate copolymer), and styrene acrylonitrile copolymer (SAN).

Combination Materials

If a combination of materials are used, they should be included as at least a first and a second material wherein said first material and said second material are different. Typically, the first material is included at a ratio of greater than about 50%, greater than about 60% or greater than about 70% in relation to the second and optional additional materials. The combination may also optionally include additional materials to the first and second material. Combination materials useful to the present invention, may include, but are not limited to the following.

First Material

The first materials of plastic parts useful in the present invention include, but are not limited to, polyesters, polyester copolymers, and mixtures thereof. Polyesters may be selected from the group consisting of polyethylene terephthalate (PET), polyester copolymers and mixtures thereof. Polyester copolymers are preferably selected from the group consisting of polyethylene terephthalate glycol-modified (PETG), polycyclohexanedimethanol terephthalate (PCT), polycyclohexanedimethanol terephthalate isophthalate (PCTA), polycyclohexanedimethanol terephthalate glycol (PCTG), and mixtures thereof. The polyester copolymers preferably comprise monomers selected from the group consisting of isophthalic acid (IPA), terephthalic acid (TPA), butane diol (BD), cyclohexanedimethanol (CHDM), ethylene glycol (EG), diethylene glycol (DEG) and mixtures thereof. Additional materials useful for the present invention include, but are not limited to, polypropylene (PP), cyclic polyolefin copolymer (COC), polystyrene (PS), Barex (Impact modified acrylonitrile-methyl acrylate copolymer), and styrene acrylonitrile copolymer (SAN).

Polyethylene terephthalate (PET) may be obtained in various forms depending upon how it is processed and crystallized. When rapidly cooled from the melt, PET can be obtained in a substantially amorphous non-crystalline form (APET) which is transparent. If PET is processed and cooled under controlled conditions, for example while being oriented in a blow molding or film stretching operation, a semi-crystalline form can be obtained which may still be transparent as long as the crystalline size is maintained below the wavelength of visible light such as from about 400 nm to about 700 nm. If PET is cooled slowly from the melt such that the crystalline structures can grow larger than the wavelength of light, it can be obtained in a semi-crystalline form which is hazy or even opaque depending upon the degree of crystallization that occurs.

Generally, the term “crystalline” or “crystallizable” PET is typically reserved for PET homopolymers, PET copolymers, or blends thereof, that are themodynarnically capable of forming crystalline structures when cooled from the melt state, or exposed in the solid state to temperatures at about or above the Tg of PET (thermal induced crystallinity), or exposed to a suitable solvent or vapor (solvent induced crystallinity). The term “non-crystallizing” PET is typically reserved for PET copolymers that substantially resist the formation of crystalline structures. These “non-crystallizing” PET materials are particularly useful in the context of the current invention since these materials can be processed into thickwall containers while substantially limiting the formation of thermal induced crystalline structures. Furthermore, these “non crystallizing” PET materials substantially resist the formation of crystalline structures resulting from exposure to solvents commonly used in consumer products. Thus, these transparent materials resist the tendency to haze or become opaque when exposed to consumer products.

Second Material

The second material of plastic parts useful in the present invention include, but are not limited to polyamides, polycarbonates, polyacrylates, polycarbonate copolymers, polyesters, polyester copolymers, and mixtures thereof. Although PCs are generally known in the art to have bad chemical tolerance and/or resistance, the present invention prefers PCs as the second material to blend with the first material. It has been discovered, contrary to the usual characteristics of PC, that when blended with the first material of the present invention, the chemical and heat resistance of the plastic parts are enhanced which contribute to the enhanced structural integrity of the plastic aerosol dispenser of the present invention. This is outside of the expected characteristics of PC because PC has very poor resistance to common solvents such as ethanol and even water. For example, a container formed from PC will rapidly haze and even crack if doused with ethanol for just a few seconds. Therefore, one would expect that blending PC with a material having better chemical resistance, such as a PET or PET copolymer, would result in a material with a lower resistance to solvents. The present invention, however, has discovered that PC can be blended with PET and PET copolymers at levels up to about 40% while providing a material with chemical resistance similar to the PET material alone. Again, realizing that PET has an undesirable thermal softening point of about 60-66° C., the blend of a polyester such as PET with PC provides an overall advantageous plastic aerosol dispenser that imparts enhanced chemical, physical and marketable characteristics that is currently absent from the art.

Polycarbonate (PC), most commonly refers to a polycarbonate plastic made from Bisphenol A, where Bisphenol A functional groups are linked together by carbonate groups to form a polymer chain. This thermoplastic material is highly transparent to visible light, has excellent mechanical properties, i.e., polycarbonate is commonly used to form “bullet proof” glass, and has very good thermal resistance. Thus, PC is useful in the context of the current invention since it has outstanding impact resistance, can form a container with very good optical clarity, and can form a container that resists thermal deformation at temperatures above about 65° C. or even above about 70° C. It is further understood, that polycarbonate materials can be synthesized from a variety of monomers and that polycarbonate random copolymers and block copolymers may also be well suited to provide the desired material properties for the current invention.

The plastic pressurized packages of the present invention comprise a minimum wall thickness of about 0.65 mm, about 1.0 mm, about 1.30 mm, about 1.95 mm, about 2.60 mm, or about 3.25 mm and may be of various shapes, for example round and non-round. Additionally, the pressurized plastic packages exhibit the following combined benefits, features and/or manufacturing methods.

High Optical Clarity

Optical clarity is characterized by both the luminous transmittance of light through a material and also by its haze value (as defined in ASTM method D1003). Packages of the present invention may have a transmittance value greater than about 85% or greater than about 90%. The initial haze value may be less than about 10%, less than about 5%, or less than about 2%.

High Impact Strength

The term “impact resistance” or “impact strength” describes an opposition to stresses which ensures that a container does not leak or rupture when exposed to mechanical stresses such as an impact on a hard surface. Packages of the present invention will withstand without damage a drop impact from a vertical distance of at least about 6 feet, at least about 10 feet, at least about 14 feet, or at least about 18 feet.

High Heat Deflection Temperature (HDT)

HDT describes the temperature at which a plastic material will become deformable under an applied load such as the pressure exerted by an aerosol propellant (defined by ASTM method D648). Packages of the present invention may have a HDT of at least about 65° C., at least about 70° C., or at least about 80° C., all under an applied load of about 66 psi.

High Chemical Resistance

Chemical resistance is the ability of a material to resist chemical or physical degradation over time due to being in contact with another chemical substance. One way to assess the chemical resistance of a material is to determine the change in haze value of the material. Haze values may be determined by standard procedures such as ASTM D 1003. The test is performed by comparing the test specimen to certified haze value standards such as that provided by BYK-Gardner, USA, Columbia, Md.

The haze level of a test sample of the material is taken. The test sample is then exposed to a chemical substance, such as a consumer product, for a controlled time period, such as at least about 1 week, and a controlled temperature, such as 49° C. Following exposure to the chemical, the haze level is measured again. If the haze level does not change, or changes very little, then the material is said to provide excellent chemical resistance to the chemical substance. If there is a substantial increase in the haze level, the material is said to have poor chemical resistance to the chemical. The change in haze level is equal to the absolute value of the initial haze value minus the final haze value, and is designated as “Δ_{haze}”. Table 1 below provides guidelines for what one could consider excellent, good, fair, or poor chemical resistance of the pressurized plastic containers of the present invention stored for 1 week at 49° C.

TABLE 1

| Chemical Resistance | Δ_{haze} |
|---|---|
| Excellent | <about 10% |
| Very Good | about 10%–about 20% |
| Good | about 20%–about 30% |
| Fair | about 30%–about 40% |
| Poor | >about 40% |

An additional method to assess the chemical resistance of a pressurized plastic container is to fill several pressurized plastic containers with a chemical substance, such as a pressurized consumer product. The filled containers are then conditioned for a controlled time period and at a controlled temperature. Elevated temperatures can be used to accelerate the rate that a chemical interaction will occur. After conditioning, the container can then be evaluated to determine if the container has been degraded by the chemical substance using technical tests such as: dropping the filled containers on a hard surface (concrete or steel) from a certain height, for example, about 6 feet; visually examining the packages for evidence of degradation such as an increase in haze (Δ_{haze}) or a change in color; and resistance to thermal deformation. The table below provides an example of a typical test procedure.

TABLE 2

| | | Description | Success Criteria |
|---|---|---|---|
| Preparation | | | |
| Steps | | | |
| 1 | Container | Measure reference dimensions of | NA |
| | Measurement | each container to be placed in | |
| | | testing (60 total containers). | |
| 2 | Container | Fill containers with consumer | NA |
| | Preparation | product to 80% capacity. | |
| | | Consumer product includes | |
| | | concentrate and propellant. | |
| 3 | Sample | Condition10 filled containers at: | NA |
| | Conditioning | about 40° C. for 12 weeks; about | |
| | | 21° C. for 26 weeks. | |
| Testing | | | |
| Steps | | | |
| 4 | Visual | Visually inspect packages for | <20% Δ_{haze}, and more |
| | Evaluation | change in haze level, discoloration, | preferably <10% Δ_{haze}; No |
| | | or other evidence of chemical | noticeable discoloration. |
| | | interaction. | |
| 5 | Impact | Drop packages from a height of 6 | No distortion, no cracks, no |
| | Resistance | feet, three times, in random | leaks. |
| | | orientation. | |
| 6 | Thermal | Bring package & contents to a | No visible and/or permanent |
| | Resistance | temperature of about 58° C. for | distortion, no leaks, no |
| | | about 2 minutes. | cracks. |

### Manufacturing of Packages

While injection stretch blow molding has proven to be a suitable manufacturer technique, other manufacturing techniques may be used. Various suppliers including, but not limited to, the Owens-Brockway Division of Owens-Illinois are capable of making packages of the present invention (e.g., specification number N-41701). In the formation of a plastic bottle formed using an Injection-Stretch-Blow-Molding (ISBM) molding process or an Injection Blow Molding (IBM) process, a semi-molten plastic tube is filled with pressurized air, thereby forcing the tube to expand outwardly to contact a mold surface in the shape of the desired container. Still another process, Injection Molding (IM), forms the container by forcing molten plastic into a mold in the desired container shape. While the use of injection blow molding (IBM) and injection stretch blow molding (ISBM) to mold clear plastic aerosol bottles has been documented, extrusion blow molding (EBM) could also be utilized for the packages of the present invention. This possibility has become a reality with the introduction of PETG and PCTG resins with increased melt strength. Materials with greater melt strength allow for the extrusion of thicker parisons and the production of thick walled bottles. In the case of optically clear bottles, possible resins include, but are not limited to, PETG and clarified polypropylene. In addition to these well known resin options, there are polyester/polycarbonate blends under development by Eastman for EBM applications. These blends provide chemical resistance and improved thermal resistance over PETG. Each of these processes, as well as other processes known to those skilled in the art, can be used to form the plastic packages of the present invention.

### Propellant/Pressurized Fluid

Several types of materials may be used to pressurize the container of the present invention. These materials include, but are not limited to, propellants and compressed gases. Propellants of the present invention include, but are not limited to, butane, isobutane, propane, dimethyl ether, 1,1difloroethane and mixtures thereof. Compressed gases of the present invention include, but are not limited to, nitrogen (N₂), carbon dioxide (CO₂), and mixtures thereof.

### EXAMPLES

The following examples illustrate the pressurized plastic containers of the present invention. Examples of the present invention are not intended to be limiting thereof:

### Example 1

The container following the steps in Table 2. Fill the bottle made of an 80/20 blend of PET/PC with 30.0 g (+/−0.3 g) concentrate of commercial body spray. Crimp on commercially available valve. Fill 20.0 g (+/−0.2 g) propellant having a pressure of about 55 psi into each bottle. Hot tank package to about 55° C. for about 2 minutes. These packages were then subjected to the test methods outlined above in Table 2. All success criteria were met.

### Comparative Example

A PET material such as Eastman EN076™ when subjected to the steps in Table 1 will have a good to fair Δ_{haze} result. A PCTG/PC blend material such as Eastman DA510™ when subjected to the steps in Table 1 will have a very good to excellent Δ_{haze} result.

Eastman EN076™ when subjected to the steps in Table 2 is likely to fail one or more steps 4-6 as outlined in Table 2. Particularly, Eastman EN076™ is likely to have a Δ_{haze} of about 20% or more. Eastman DA510™, however, when subjected to the steps in Table 2 is likely to pass all steps 4-6 as outlined in Table 2. Particularly, Eastman DA510™ is likely to have a Δ_{haze} of less than 20%.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the term in a document incorporated herein by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A plastic pressurized package comprising a hollow, plastic, substantially non-round cross-section body, comprising a polymer selected from the group consisting of polyamides, polyesters, polyester copolymers, polycarbonates, polyacrylates, polycarbonate copolymers, and mixtures thereof wherein said plastic pressurized package is able to contain and dispense a pressurized fluid of at least about 15 psi greater than atmospheric pressure at 25° C.

2. The plastic pressurized package of claim 1 wherein said package has a wall thickness of from about 0.65 mm to about 3.25 mm.

3. The plastic pressurized package of claim 1 wherein said package has a Δ_{haze} value of less than about 40%.

4. The plastic pressurized package of claim 1 wherein said package has a heat deflection temperature of at least about 65° C. under an applied load of about 66 psi.

5. The plastic pressurized package of claim 1 wherein said package has a thermal resistance of at least about 58° C.

6. The plastic pressurized package of claim 1 wherein said material is a polyester selected from the group consisting of polyethylene terephthalate, polyester copolymers, and mixtures thereof.

7. The plastic pressurized package of claim 1 wherein said material is a polyester copolymer selected from the group consisting of polyethylene terphthalate glycol-modified, polycyclohexanedimethanol terephthalate, polycyclohexanedimethanol terephthalate isophthalate, polycyclohexanedimethanol terephthalate glycol, and mixtures thereof.

8. The plastic pressurized package of claim 6 wherein the polyester is a polyester copolymer.

9. The plastic pressurized package of claim 8 wherein the polyester copolymer is non-crystalline.

10. The plastic pressurized package of claim 9 wherein the polyester copolymer is amorphous.

11. The plastic pressurized package of claim 1 wherein said material is polycarbonate.

12. The plastic pressurized package of claim 1 wherein said material is polyamide.

13. The plastic pressurized package of claim 1 wherein said package has an initial haze value of less than about 10%.

14. The plastic pressurized package of claim 1 wherein said package exhibits a high impact resistance of at least about 6 feet.

15. The plastic pressurized package of claim 1 further comprising an additional material selected from the group consisting of colorants, fillers, additives, and mixtures thereof.

16. A plastic pressurized package comprising a hollow, plastic, substantially non-round cross-section body, comprising a blend of a first and second material, said first material comprising a polymer selected from the group consisting of polyesters, polyester copolymers and mixtures thereof and said second material comprising a polymer selected from the group consisting of polyamides, polycarbonates, polyacrylates, polycarbonate copolymers, polyesters, polyester copolymers and mixtures thereof wherein said first material and said second material are different and wherein said plastic pressurized package is able to contain and dispense a pressurized fluid of at least about 15 psi greater than atmospheric pressure at 25° C.

17. The plastic pressurized package of claim 1 wherein said first material is polyethylene terephthalate and said second material is polycarbonate.

18. The plastic pressurized package of claim 1 further comprising at least one additional material wherein said at least one additional material is a polymer selected from the group consisting of polyesters, polyester copolymers, polyamides, polycarbonates, polyacrylates, polycarbonate copolymers, and mixtures thereof wherein said third material is different from said first and said second material.

19. The plastic pressurized package of claim 16 further comprising an additional material selected from the group consisting of colorants, fillers, additives, and mixtures thereof.

20. A plastic pressurized package comprising a hollow, plastic, substantially non-round cross-section body, comprising a polymer selected from the group consisting of polyamides, polyesters, polyester copolymers, polycarbonates, polyacrylates, polycarbonate copolymers, polypropylene, cyclic polyolefin copolymer, polystyrene, Barex, styrene acrylonitrile copolymer and mixtures thereof wherein said plastic pressurized package is able to contain and dispense a pressurized fluid of at least about 15 psi greater than atmospheric pressure at 25° C.
